(19) United States
(12) Patent Application Publication
(10) Pub. No.: US 2005/0043479 A1
(43) Pub. Date: Feb. 24, 2005

(54) Preparation of polysiloxane-containing compositions and their use for imparting water repellency to or refatting materials having a fibrous structure

(76) Inventors: Rainer Erhardt, Mannheim (DE); Gunter Scherr, Ludwigshafen (DE); Gunther Pabst, Neumarkt i. d. OPf. (DE); Ralph Lunkwitz, Neustadt (DE)

Correspondence Address: Herbert B. Keil;KEIL & WEINKAUF, 1350 Connecticut Ave., N.W., Washington, DC, 20036, US

(21) Appl. No.: 10/909,286

(22) Filed: Aug. 3, 2004

(30) Foreign Application Priority Data
Aug. 20, 2003 (DE) 10338920.2

(51) Int. Cl. C08L 83/08

(52) U.S. Cl. 524/860

(57) ABSTRACT

Compositions comprising the following components:
(A) at least one carboxyl-containing polysiloxane which has at least one structural element of the formula Ia, Ib or Ic 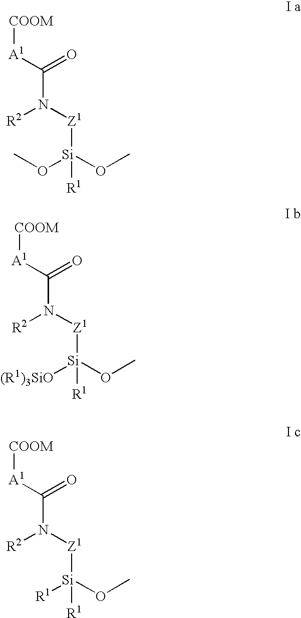 per molecule, (B1) at least one aprotic substance which is liquid at room temperature or (B2) at least one organic solvent, (C) up to 2% by weight, based on the weight of the composition, of water, the variables being defined as follows:
R¹ is hydrogen, hydroxyl, C₁-C₆-alkyl, C₆-C₁₄-aryl or C₁-C₄-alkoxy,
R² is hydrogen or C₁-C₆-alkyl,
Z¹ is C₂-C₂₅-alkylene, C₃-C₁₀-cycloalkylene, C₆-C₁₄-arylene, —[(CH₂)ₙ—NR²—(CH₂)ₘ]ₚ, 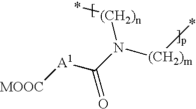 n and m are integers which are identical or different and are from 1 to 10, p is an integer from 1 to 5,
A¹ is C₂-C₂₀-alkylene, unsubstituted or substituted by R³ and/or R⁴, —CH═CR³—, 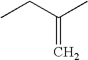
R³ and R⁴ are identical or different and are selected from hydrogen, C₁-C₂₀-alkyl, C₂-C₂₀-alkenyl, C₆-C₁₄-aryl and C₁-C₄-alkoxy;
   it being possible for R³ and R⁴ to be linked to one another with formation of a mono- or bicyclic system, M are identical or different and are selected from hydrogen, alkali metal and ammonium, which may be substituted or cyclic,
      are prepared by a process wherein at least one amino-containing polysiloxane which has at least one structural element of the formula IIa, IIb or IIc 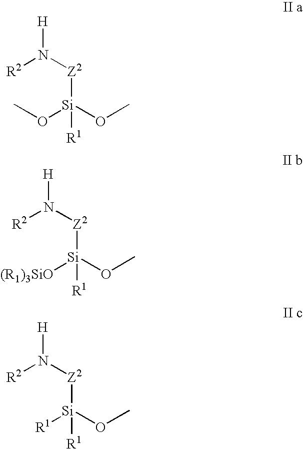
   per molecule is reacted, in the presence or absence of component (B1),
      with at least one dicarboxylic anhydride of the formula IIIa or at least one dicarboxylic acid derivative of the formula IIIb 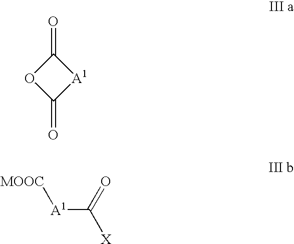 X being a leaving group and
Z² being C₂-C₂₅-alkylene, C₃-C₁₀-cycloalkylene, C₆-C₁₄-arylene or —[(CH₂)ₙ—NR²—(CH₂)ₘ]ₚ, and then, if required, component (B1) or (B2) is added.

The present invention relates to a process for the preparation of compositions comprising the following components:
(A) at least one carboxyl-containing polysiloxane which has at least one structural element of the formula Ia, Ib or Ic 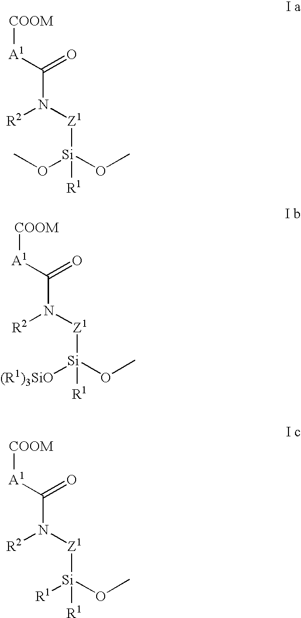
   per molecule,
(B1) at least one aprotic substance which is liquid at room temperature or
(B2) at least one organic solvent,
(C) up to 2% by weight, based on the weight of the composition, of water,
   the variables being defined as follows:
R¹ is hydrogen, hydroxyl, C₁-C₆-alkyl, C₆-C₁₄-aryl or C₁-C₄-alkoxy,
R² is hydrogen or C₁-C₆-alkyl,
Z¹ is C₂-C₂₅-alkylene, C₃-C₁₀-cycloalkylene, C₆-C₁₄-arylene, —[(CH₂)ₙ—NR²—(CH₂)ₘ]ₚ, 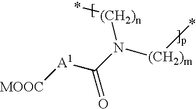
n and m are integers which are identical or different and are from 1 to 10,
p is an integer from 1 to 5,
A¹ is C₂-C₂₀-alkylene, unsubstituted or substituted by R³ and/or R⁴, —CH═CR³—, —CR⁴═CR³—, 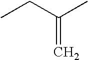
R³ and R⁴ are identical or different and are selected from hydrogen, C₁-C₂₀-alkyl, C₂-C₂₀-alkenyl, C₆-C₁₄-aryl and C₁-C₄-alkoxy;
   it being possible for R³ and R⁴ to be linked to one another with formation of a mono- or bicyclic system,
M are identical or different and are selected from hydrogen, alkali metal and ammonium, which may be substituted or cyclic,
   wherein at least one amino-containing polysiloxane which has at least one structural element of the formula IIa, IIb or IIc 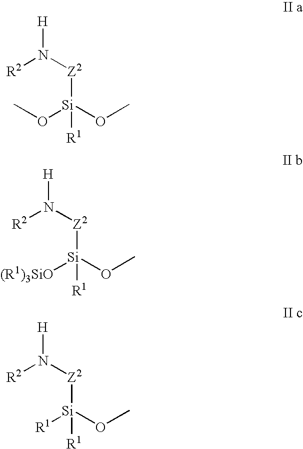
   per molecule is reacted, in the presence or absence of component (B1),
   with at least one dicarboxylic anhydride of the formula IIIa or at least one dicarboxylic acid derivative of the formula IIIb 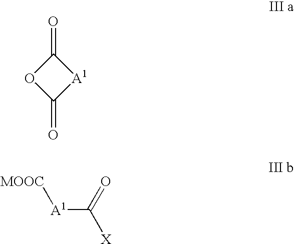
      X being a leaving group and
Z² being C₂-C₂₅-alkylene, C₃-C₁₀-cycloalkylene, C₆-C₁₄-arylene or —[(CH₂)ₙ—NR²—(CH₂)ₘ]ₚ,
   and then, if required, component (B1) or (B2) is added.

The present invention furthermore relates to compositions obtainable by the novel process, and their use for imparting water repellency to or refatting materials having a fibrous structure.

EP-A 1 041 189 discloses compositions comprising at least one cyclic siloxane and one polyethersiloxane. They are suitable for cleaning fabrics and leather in the absence of water.

GB 2,270,081 discloses mixtures comprising a cyclic siloxane and a polysiloxane which preferably has an alkylamino group or a dialkylamino group on the terminal silicon atom.

WO 98/21369 discloses aqueous emulsions of carboxamide-polysiloxanes and their use during or after the retanning in an aqueous liquor. The carboxamide-polysiloxanes disclosed are prepared in the form of their aqueous emulsions.

WO 03/23124 mentions compositions for cleaning leather articles, comprising
80-99.999% of lipophilic liquid, e.g. cyclic siloxane, such as decamethylcyclopentasiloxane,
0-5% of water,
0-5% of a leather additive, for example a fatliquoring agent, e.g. a carboxamide-polysiloxane according to WO 98/21369, a waterproofing composition, a dye transfer inhibitor, a fixing agent, a tanning agent or a perfume, and
from 0.001 to 5% of a water-insoluble treatment composition, it being possible for the treatment composition to have siloxane groups and preferably to have a propoxy group or a larger alkoxy group, ethoxy groups and propoxy groups in a specific ratio, a silicone group, an HLB value (hydrophilic-lipophilic balance) of less than 9, an OH group, no charge group and no nitrogen-containing group (page 12, line 17 et seq.).

Furthermore, WO 03/23124 mentions treatment compositions for leather articles, the treatment compositions being composed of
from about 1 to about 100% of a treatment composition,
from 0 to about 99% of water,
from 0 to 99% of a lipophilic liquid, e.g. a cyclic siloxane, for example decamethylcyclopentasiloxane and
optionally from 0 to about 99% of a leather additive.

However, WO 03/23124 discloses neither a process for the preparation of said compositions for cleaning nor a process for the preparation of said treatment compositions for leather articles. In particular, WO 03/23124 discloses no economical process for the preparation of those compositions for cleaning or treatment compositions which contain only a small amount of water.

It is an object of the present invention to provide a process for the preparation of compositions which are particularly suitable for imparting water repellency to or refatting materials having a fibrous structure.

It is a further object of the present invention to provide compositions for imparting water repellency to or refatting materials having a fibrous structure. Finally, it is an object of the present invention to provide a process for imparting water repellency to or refatting materials having a fibrous structure.

We have found that these objects are achieved by the process defined at the outset.

The novel process is suitable for the preparation of compositions comprising the components
(A) at least one carboxyl-containing polysiloxane which has at least one structural element of the formula Ia, Ib or Ic 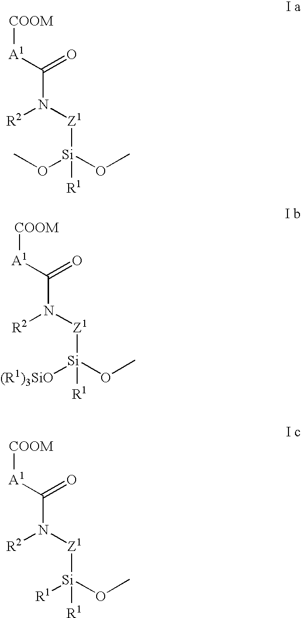
   per molecule,
   the variables being defined as follows:
R¹ is hydrogen,
   hydroxyl,
C₁-C₆-alkyl, such as methyl, ethyl, n-propyl, isopropyl, n-butyl, isobutyl, sec-butyl, tert-butyl, n-pentyl, isoamyl, isopentyl; n-hexyl, isohexyl or sec-hexyl, particularly preferably methyl,
C₆-C₁₄-aryl, such as phenyl, 1-naphthyl, 2-naphthyl, 1-anthryl, 2-anthryl, 9-anthryl, 1-phenanthryl, 2-phenanthryl, 3-phenanthryl, 4-phenanthryl or 9-phenanthryl, preferably phenyl, 1-naphthyl or 2-naphthyl, particularly preferably phenyl,
C₁-C₄-alkoxy, such as methoxy, ethoxy, n-propoxy, isopropoxy, n-butoxy, isobutoxy, sec-butoxy, tert-butoxy;
R² is C₁-C₆-alkyl, such as methyl, ethyl, n-propyl, isopropyl, n-butyl, isobutyl, sec-butyl, tert-butyl, n-pentyl, isoamyl, isopentyl, n-hexyl, isohexyl or sec-hexyl, in particular methyl,
   very particularly preferably hydrogen,
Z¹ is C₂-C₂₅-alkylene, preferably C₂-C₁₀-alkylene, such as —(CH₂)₂—, —CH₂—CH(CH₃)—, —(CH₂)₃—, —CH₂—CH(C₂H₅)—, —(CH₂)₄—, —(CH₂)₅—, —(CH₂)₆—, —(CH₂)₇—, —CH₂)₈—, —(CH₂)₉—, —(CH₂)₁₀—, preferably C₂-C₄-alkylene, in particular —(CH₂)₂—, —CH₂—CH(CH₃)—, —(CH₂)₃—, —(CH₂)₄— and —CH₂—CH(C₂H₅)—,
   C₃-C₁₀-cycloalkylene, such as 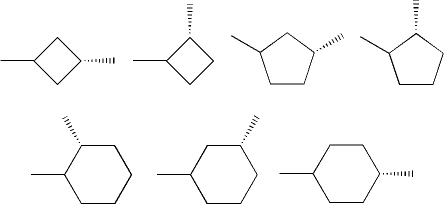
   particularly preferably 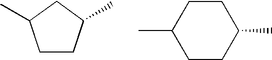
C₆-C₁₄-arylene, for example 1,5-naphthylene, 2,7-naphthylene and preferably ortho-phenylene, meta-phenylene and particularly preferably para-phenylene,
—[(CH₂)ₙ—NR²—(CH₂)ₘ]ₚ, 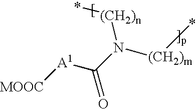
n and m are integers which are identical or different and are from 1 to 10, preferably from 2 to 5, and particularly preferably m is 3 and n is 2,
A¹ are different or preferably identical and are selected from
   C₂-C₂₀-alkylene, unsubstituted or substituted by R³ and/or R⁴, preferably —(CH₂)₂—, —CH₂—CHR³—, cis- and trans-CHR³—CHR⁴—, —(CH₂)₃—, —(CH₂)₄—, —(CH₂)₅—, —(CH₂)₆—, —(CH₂)₇—, —(CH₂)₈—, —(CH₂)₉—, —(CH₂)₁₀—, —CH═CR³, —CR⁴═CR³—, 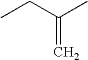
R³ and R⁴ are identical or different and are selected from hydrogen,
C₁-C₂₀-alkyl, preferably C₁-C₁₂-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl, n-undecyl or n-dodecyl, particularly preferably C₁-C₄-alkyl, such as methyl, ethyl, n-propyl, isopropyl, n-butyl, isobutyl, sec-butyl or tert-butyl, in particular methyl,
C₂-C₂₀-alkenyl, preferably ω-C₂-C₂₀-alkenyl, such as vinyl, β-allyl, ω-butenyl, ω-pentenyl, ω-hexenyl, ω-heptenyl, ω-octenyl, ω-nonenyl or ω-decenyl,
C₆-C₁₄-aryl, such as phenyl, 1-naphthyl, 2-naphthyl, 1-anthryl, 2-anthryl, 9-anthryl, 1-phenanthryl, 2-phenanthryl, 3-phenanthryl, 4-phenanthryl or 9-phenanthryl, preferably phenyl, 1-naphthyl or 2-naphthyl, particularly preferably phenyl,
C₁-C₄-alkoxy, such as methoxy, ethoxy, n-propoxy, isopropoxy, n-butoxy, isobutoxy, sec-butoxy or tert-butoxy,
R³ and R⁴ may be linked to one another with formation of a mono- or bicyclic system, so that A¹ may be, for example, 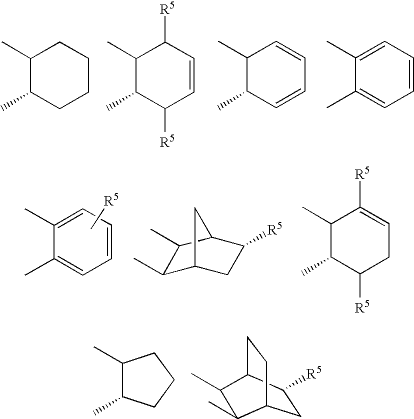
R⁵ are identical or different and, independently of one another, are
C₁-C₆-alkyl, such as methyl, ethyl, n-propyl, isopropyl, n-butyl, isobutyl, sec-butyl, tert-butyl, n-pentyl, isoamyl, isopentyl; n-hexyl, isohexyl or sec-hexyl, in particular methyl,
C₆-C₁₄-aryl, such as phenyl, 1-naphthyl, 2-naphthyl, 1-anthryl, 2-anthryl, 9-anthryl, 1-phenanthryl, 2-phenanthryl, 3-phenanthryl, 4-phenanthryl or 9-phenanthryl, preferably phenyl, 1-naphthyl or 2-naphthyl, particularly preferably phenyl,
C₁-C₄-alkoxy, such as methoxy, ethoxy, n-propoxy, isopropoxy, n-butoxy, isobutoxy, sec-butoxy or tert-butoxy,
   COOM or in particular hydrogen,
M are identical or different and are selected from hydrogen and preferably
   alkali metal, such as Li⁺, Na⁺, K⁺, Rb⁺ or Cs⁺, in particular Na⁺ or K⁺, and ammonium, unsubstituted or substituted, for example methylammonium, dimethylammonium, trimethylammonium, tetramethylammonium, ethylammonium, diethylammonium, triethylammonium, tetraethylammonium, piperidinium, oxygen-containing ammonium, such as ethanolammonium, diethanolammonium, triethanolammonium, N-methylethanolammonium, N-methyldiethanolammonium and N-(n-butyl)diethanolammonium and

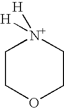

In a preferred embodiment of the present invention, all R¹ in the carboxyl-containing polysiloxane are identical and are each methyl.

In an embodiment of the present invention, carboxyl-containing polysiloxane furthermore contains structural elements of the formula IV and optionally of the formulae Va and/or Vb

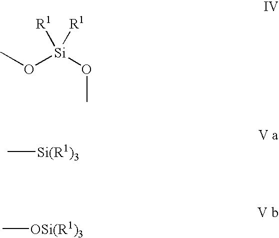

R¹ having the above meanings.

Very particularly preferred structural elements of the formula IV are —O—Si(CH₃)₂—O and —O—Si(CH₃)(C₆H₅)—O—.

In an embodiment, the structural elements IV in carboxyl-containing polysiloxanes (A) are different in each case, in each case one R¹ per silicon atom being methyl and the other R¹ being phenyl.

In an embodiment of the present invention, the structural elements of the formula Va in carboxyl-containing polysiloxane (A) are selected from the following groups: —Si(CH₃)₃, —Si(CH₃)₂C₆H₅, —Si(CH₃)₂OH, —Si(CH₃)C₆H₅OH.

In an embodiment of the present invention, the structural elements of the formula Vb in carboxyl-containing polysiloxane (A) are selected from the following groups: —OSi(CH₃)₃, —OSi(CH₃)₂C₆H₅, —OSi(CH₃)₂OH, —OSi(CH₃)C₆H₅OH.

It is possible for carboxyl-containing polysiloxanes (A) to have different structural elements, selected from Ia, Ib and Ic; for example, it is within the scope of the present invention for a novel composition to contain a carboxyl-containing polysiloxane (A) which has at least one structural element of the formula I a and at least one structural element of the formula Ib.

In the context of the present invention, the term at least one structural element of the formula Ia, Ib or Ic per molecule is always to be understood as meaning average values.

Carboxyl-containing polysiloxanes which contain the structural elements of the formulae Ia or Ib or Ic, IV and optionally Va and/or Vb may be linear or may have a cyclic or branched structure. Branched polysiloxanes which contain the structural elements Ia or Ib or Ic, IV and optionally Va and/or Vb may additionally contain structural elements of, for example, the formula VIa or VIb 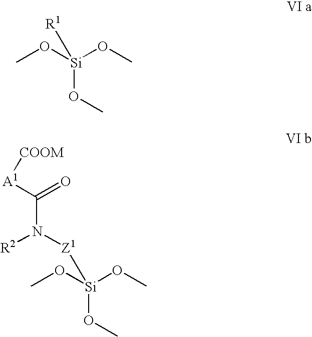
in which the variables are defined as above. Cyclic straight-chain polysiloxanes which contain the structural elements of the formulae Ia or Ib or Ic and IV usually contain no structural elements of the formulae Va and Vb.

In an embodiment, compositions obtainable by the novel process may contain at least one aprotic substance (B1) which is liquid at room temperature. Suitable aprotic substances (B1) which are liquid at room temperature are, for example, liquid paraffins, such as n-hexane, n-heptane, cyclohexane, isooctane, n-octane, meta-xylene or tert-butylmethylhexane, and esters, preferably C₁-C₄-alkyl esters, of C₁-C₁₀-carboxylic acids, in particular C₁-C₂-alkyl esters, for example ethyl n-decanoate.

In an embodiment of the present invention, component (B1) is a linear, branched or preferably cyclic carboxyl-free polysiloxane. In the context of the present invention, linear, branched and cyclic carboxyl-free polysiloxanes are composed of structural elements of the formulae VII, optionally VIIIa and/or VIIIb and optionally IXa; 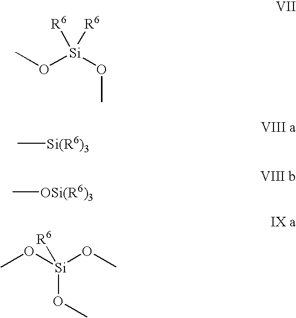
branched carboxyl-free polysiloxanes may furthermore contain structural elements of the formula IXa. There,
R⁶ is hydrogen,
C₁-C₆-alkyl, such as methyl, ethyl, n-propyl, isopropyl, n-butyl, isobutyl, sec-butyl, tert-butyl, n-pentyl, isoamyl, isopentyl, n-hexyl, isohexyl or sec-hexyl, particularly preferably methyl,
C₆-C₁₄-aryl, such as phenyl, 1-naphthyl, 2-naphthyl, 1-anthryl, 2-anthryl, 9-anthryl, 1-phenanthryl, 2-phenanthryl, 3-phenanthryl, 4-phenanthryl or 9-phenanthryl, preferably phenyl, 1-naphthyl or 2-naphthyl, particularly preferably phenyl,
C₁-C₄-alkoxy, such as methoxy, ethoxy, n-propoxy, isopropoxy, n-butoxy, isobutoxy, sec-butoxy or tert-butoxy,
C₇C₃₀-aralkyl, composed of C₁-C₆-alkylene, which is substituted by a plurality of C₆-C₁₄-aryl groups or preferably one C₆-C₁₄-aryl, which in turn may be substituted by one or more C₁-C₄-alkyl, for example 1-phenylethyl, 2-phenylethyl, 1-phenyl-n-propyl, 2-phenyl-n-propyl, 3-phenylpropyl, 2-(1-naphthylethyl), 2-(1-naphthylmethyl) and in particular benzyl.

Very particularly preferred structural elements of the formula VII in carboxyl-free polysiloxane are —O—Si(CH₃)₂—O— and —O—Si(CH₃)(C₆H₅)—O—.

In an embodiment of the present invention the structural elements of the formula VIIIa in carboxyl-free polysiloxane are selected from the following groups: Si(CH₃)₃, Si(CH₃)₂C₆H₅, Si(C₆H₅)₂CH₃.

Particularly preferably, component (B1) is octamethylcyclotetrasiloxane, decamethylcyclopentasiloxane, dodecamethylcyclohexasiloxane or tetradecamethylcycloheptasiloxane. Octamethylcyclotetrasiloxane and decamethylcyclopentasiloxane are particularly preferred; decamethylcyclopentasiloxane is very particularly preferred.

Many cyclic polysiloxanes are commercially available or can be prepared by processes known to a person skilled in the art, for example by hydrolysis and condensation of dimethyldichlorosilane. In the preparation of polysiloxanes having less than three silicon atoms, the procedure should be carried out in closed apparatuses or under inert gas, owing to the low ignition temperatures of these compounds. Suitable working techniques are known to a person skilled in the art.

Other suitable substances (B1) are acyclic carboxyl-free siloxanes, composed of structural elements of the formulae VII, optionally VIIIa and/or VIIIb and optionally IXa; linear decamethyltetrasiloxane is particularly preferred.

It is possible to use high molecular weight linear or cyclic carboxyl-free polysiloxanes as component (B1) in the compositions according to the invention. It is preferable if the viscosity of the linear or cyclic carboxyl-free polysiloxane as component (B1) is so low that the novel compositions are readily stirrable. The maximum dynamic viscosity of the cyclic polysiloxanes is preferably 700, especially 500, mPa·s. Cyclic polysiloxanes having a viscosity of from 100 to 300 mPa·s are particularly preferably used. The viscosity is measured by dynamic viscosity measurement using a cone-and-plate viscometer (model Haake PK 100/Rotovisco RV 20, measuring head: 256-0505) according to DIN 12879.

In another embodiment of the present invention, compositions according to the invention contain at least one organic solvent (B2) which may be protic, in particular ethanol or isopropanol.

Novel compositions furthermore contain up to 2% by weight of water, in one embodiment from 10 ppm to 2% by weight, preferably from 100 ppm to 1.5% by weight, particularly preferably from 150 ppm to 0.25% by weight, of water (C), based in each case on the weight of the composition. The water content can be determined by a person skilled in the art by methods known per se, for example Karl Fischer titration according to DIN 51777.

The novel process is carried out starting from at least one polysiloxane which has at least one structural element of the formula IIa, IIb or IIc 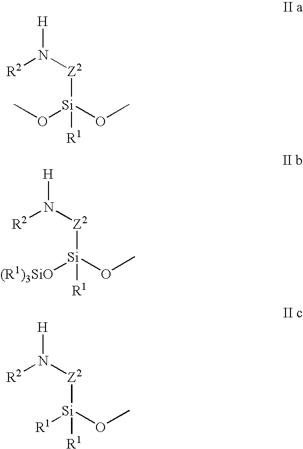
per molecule, also referred to below as amino-containing polysiloxane, and furthermore structural elements of the formulae IV and optionally Va and Vb,
and reacting with at least one dicarboxylic anhydride of the formula IIIa or IIIb

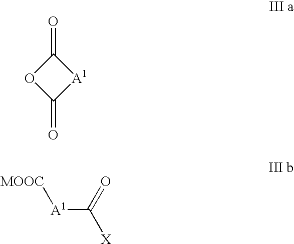

Here, the variables are defined as follows:
Z² is selected from
   C₂-C₂₅-alkylene, C₃-C₁₀-cycloalkylene, C₆-C₁₄-arylene and —[(CH₂)ₙ—NR²—(CH₂)ₘ]ₚ, in each case defined as above, and X is a leaving group.

The other variables are defined as above.

The amino-containing polysiloxanes used as starting material are obtainable by methods known per se to a person skilled in the art, for example by hydrolysis of mixtures of silyl compounds, as described in WO 98/21369, page 11 et seq., or by analogous methods.

Amino-containing polysiloxanes used as starting material advantageously have a dynamic viscosity of from 10 to 700 mPa·s, which corresponds to an average molecular weight Mₙ of from about 500 to about 60 000 g/mol. The dynamic viscosity is preferably from 80 to 100 mPa·s.

It is preferable to react an amino-containing polysiloxane with a dicarboxylic anhydride of the formula IIIa.

The other variables are defined as above and, in the context of the present invention, the term at least one structural element of the formula IIa, IIb or IIc per molecule is always to be understood as meaning average values.

If it is desired to prepare branched carboxyl-containing polysiloxanes as component (A), it is possible to use an amino-containing polysiloxane which has structural elements of the formula IId 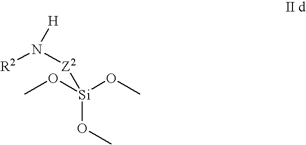
and to react it analogously with a dicarboxylic anhydride of the formula IIIa or with a dicarboxylic acid derivative of the formula IIIb.

In an embodiment of the present invention, the novel preparation process is carried out so that (B1) serves as a solvent.

In another embodiment of the present invention, the reaction of the amino-containing polysiloxane with IIIa or IIIb is carried out in the absence of (B1); (B1) or (B2) is then added after the end of the chemical reaction.

The reaction of the amino-containing polysiloxane with IIIa or IIIb is carried out in the absence of (B2).

In an embodiment, (B1) and (B2) can be added.

Component (B1) or (B2) can be freed from water contained by methods known to a person skilled in the art, for example by distillation, if required together with a drying agent. In general, however, it is not necessary to carry out expensive steps in order to remove amounts of water which arise from the preparation of (B1) or (B2) if the amount of water does not exceed 2% by weight, based on the novel composition.

In an embodiment of the present invention, (B1) can be partially removed from the novel preparation process after the reaction. However, it is preferable not to remove (B1) after the reaction.

In an embodiment of the present invention, the novel preparation process is carried out at from room temperature to 100° C., preferably from 40 to 80° C.

In an embodiment of the present invention, IIIa or IIIb and amino groups of amino-containing polysiloxane are used in a molar ratio of from 0.4:1 to 1:1, preferably from 0.5:1 to 0.98:1, i.e. an excess of amino groups or an equimolar amount of amino groups relative to IIIa or IIIb is chosen.

If a molar ratio of amino groups of IIIa or IIIb to amino-containing polysiloxane of from 0.4:1 to 0.5:1 is chosen, it is advantageous to dispense with the neutralization with amine in the reaction.

In an embodiment of the present invention, carboxyl-containing polysiloxanes may additionally have structural elements of the formulae IIa, IIb and/or IIc and, if required, IId 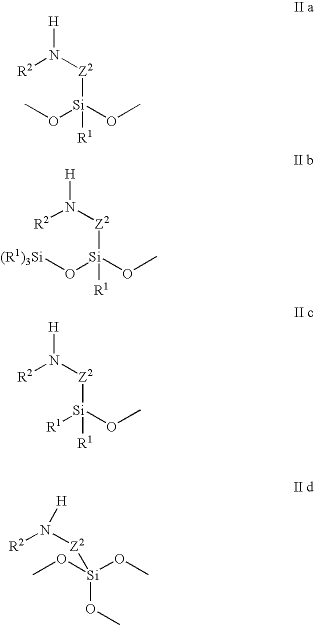
in which the variables are defined as above. This is the case particularly when less than equimolar amounts of IIIa or IIIb per amino group of amino-containing polysiloxane are used.

The structural elements Ia, IV and optionally IIa in the carboxyl-containing polysiloxanes prepared according to the invention may be distributed alternately, blockwise or preferably randomly in carboxyl-containing polysiloxanes.

If R² is hydrogen, structural elements Ia, Ib and Ic of the carboxyl-containing polysiloxanes can react partially to give structural elements of the formulae VIIa, VIIb and VIIc

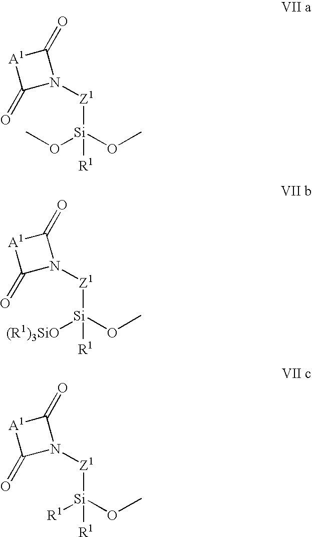

This is the case particularly when A¹ is chosen as ortho-C₆H₄.

In an embodiment of the present invention, the molecular weight Mₙ of carboxyl-containing polysiloxane (A) is from 500 to 60 000, preferably from 2 500 to 5 000, g/mol.

The molecular weight determination can be carried out by methods known per se to a person skilled in the art, for example by light scattering methods or viscosity determinations.

In an embodiment of the present invention, at least one carboxyl-containing polysiloxane (A) contains from 0.02 to 1.0, preferably from 0.1 to 0.3, meq/g of carboxyl groups. The content of carboxyl group can be determined, for example, titrimetrically by determining the acid number.

In an embodiment of the present invention, novel compositions may contain at least one substance which is solid at room temperature as component (D).

Examples of suitable substances which are solid at room temperature are natural and synthetic waxes, natural and synthetic fats, tallow fatty alcohols and tallow fatty amines.

Examples of natural waxes are beeswax, cork wax, montan waxes and carnauba wax.

Examples of synthetic waxes are polyethylene waxes, as obtainable, for example, by free radical polymerization of ethylene or by Ziegler-Natta catalysis. Polyisobutylene waxes may furthermore be mentioned. It is also possible to mention paraffin mixtures; these are understood as meaning mixtures of hydrocarbons which have 12 or more carbon atoms and usually have a melting point of from 25 to 45° C. Such paraffin mixtures may be obtained, for example, in refineries or crackers and are known to a person skilled in the art as paraffin slack wax and sasol waxes. A further example of synthetic waxes comprises montan ester waxes.

Examples of natural fats are natural triglycerides which are solid at room temperature, such as lanolin, shellac wax and mixtures thereof, and furthermore fish oil and bone oil. In the context of the present invention, fatty acids and solid paraffins having a melting point of from 21 to 100° C. may also be mentioned.

Examples of synthetic fats are synthetic triglycerides which are solid at room temperature.

If it is desired to prepare such novel compositions which have at least one component (D), it is possible, for example, to adopt a procedure in which component (A) is first prepared in the presence of component (B1) by a process described above and is then mixed with (D).

It is also possible to adopt a procedure in which component (A) is prepared in the absence of component (B1) by a process described above and is then mixed with (B1) or (B2) and with (D).

In an embodiment of the present invention, novel compositions may contain at least one emulsifier as component (E).

Suitable emulsifiers are surface-active compounds of nonionic, anionic, cationic or amphoteric character. In particular, N-(C₉- to C₂₀-acyl)amino acids having 2 to 6 carbon atoms in the amino acid parent structure, such as N-oleoylsarcosine, N-stearoylsarcosine, N-lauroylsarcosine or N-isononanoylsarcosine, are suitable, the latter generally being present in the form of their alkali metal, ammonium or trialkanolamine salts. Other particularly suitable emulsifiers are sulfonylsuccinic monoesters in the form of their sodium, potassium or ammonium salts. It is also possible to use mixtures of different emulsifiers.

If it is desired to prepare those novel compositions which have at least one component (E), it is possible, for example, to adopt a procedure in which component (A) is first prepared in the presence of component (B1) by a process described above and is then mixed with (E).

It is also possible to adopt a procedure in which component (A) is prepared in the absence of component (B1) by a process described above and is then mixed with (B1) or (B2) and with emulsifier (E).

In an embodiment of the present invention, novel compositions contain, based in each case on the total weight of the composition,
from 5.5 to 90, preferably from 6 to 60, particularly preferably from 30 to 40, % by weight of component (A),
from 10 to 94, preferably from 40 to 93.5, particularly preferably from 60 to 68, % by weight of component (B1) or
from 10 to 94, preferably from 40 to 93.5, particularly preferably from 60 to 68, % by weight of component (B2) or
from 10 to 94, preferably from 40 to 93.5, particularly preferably from 60 to 68, % by weight of a mixture of components (B1) and (B2), for example in a weight ratio of from 1:50 to 50:1,
from 0 to 2% by weight, preferably from 100 ppm to 1.5% by weight, particularly preferably from 150 ppm to 1% by weight, of water (C),
from 0 to 50, preferably from 10 to 20, % by weight of component (D),
from 0 to 10, preferably from 0 to 4, particularly preferably from 0.1 to 3, % by weight of emulsifier (E).

The present invention furthermore relates to the use of novel compositions for imparting water repellency to or refatting materials having a fibrous structure.

Materials having a fibrous structure are preferably to be understood as meaning leather, fur skins and textiles.

The present invention furthermore relates to a process for imparting water repellency to or refatting materials having a fibrous structure, comprising the following steps:
a) applying a novel composition to material having a fibrous structure,
b) allowing to act with or without simultaneously carrying out mechanical treatment steps,
c) optionally washing and drying.

Novel compositions can generally be applied in amounts of from 0.01 to 20, in particular from 0.5 to 15, % by weight, based on the wet weight of the fibrous material, in particular based on the shaved weight of leather or the dry weight of textile or fur skins.

If leathers or fur skins are to be rendered water repellent or refatted according to the invention, this is generally effected after the retanning.

In an embodiment of the present invention, the novel imparting of water repellency or refatting is effected after the partial drying and shaving or the drying of the wet white or wet blue leather or particularly preferably after the retanning and subsequent drying, in the case of leathers or fur skins after the retanning, as a rule with drumming in a suitable apparatus, for example in rotatable drums having internals, at liquor lengths of from 1 to 500%, preferably from 50 to 200%, based on the dry or shaved weight of the material having a fibrous structure, in particular based on the shaved weight of the leather or wet weight of the fur skin, at from 5 to 70° C., preferably from 10 to 60° C., particularly preferably from 15 to 55° C. In general, the steps (a) and (b) are complete after a time of from 5 minutes to 10 hours, preferably from 15 minutes to 5 hours, particularly preferably from 30 minutes to 2 hours, altogether.

In an embodiment of the present invention, from about 2 to 20, preferably from 5 to 15, % by weight, based on fibrous material and in particular on leather, of novel formulation are applied by, for example, coating or spraying on (step (a)). It is then allowed to act for, for example, from 5 minutes to 24 hours, preferably from 30 minutes to 5 hours, (step (b)), after which drumming can be effected over a certain period, for example from 5 minutes to 24 hours, preferably from 30 minutes to 5 hours, in a suitable apparatus, for example in rotatable drums having internals. In the embodiment described, it is possible to dispense with a liquor. For example, temperatures of from 10 to 70° C., preferably from room temperature to 50° C., are suitable as the temperature for the period of action and any drumming. Drying can subsequently be effected (step (c)).

When polysiloxanes having less than three silicon atoms are used as component (B1), their low ignition temperature must be taken into account. The imparting of water repellency or refatting with novel compositions which contain siloxanes having a low ignition temperature should therefore be carried out in a closed system or under inert gas. Suitable apparatuses are known to a person skilled in the art.

Washing in step (c) can be carried out, for example, with further component (B1), particularly advantageously with octamethylcyclotetrasiloxane, decamethylcyclopentasiloxane or dodecamethylcyclohexasiloxane or mixtures of the abovementioned cyclic polysiloxanes.

The drying in step (c) can be carried out, for example, at from 40 to 75° C. The drying in step (c) can be accelerated by passing through an air or inert gas stream. The drying in step (c) can be accelerated by centrifuging. It is also possible to carry out the drying in step (c) in the form of drying under reduced pressure.

The working examples which follow illustrate the invention.

1. Preparation of Novel Compositions

### EXAMPLE 1.1

53.60 g (40 mmol of amino groups, determined by titration) of an amino-containing polysiloxane comprising randomly distributed structural units IIa.1 (R¹═CH₃, R²═H, Z²═—(CH₂)₃—NH—(CH₂)₂—, IV.1 and V.a.1 (R⁶═CH₃) 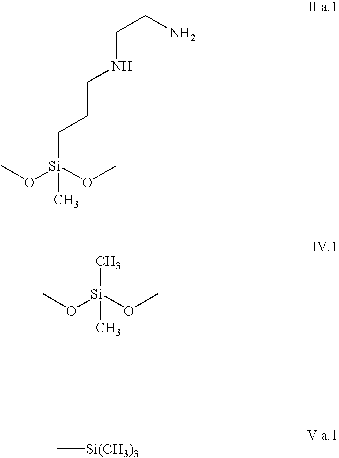
(amine titer: 0.746 mmol/g according to ISO 6618), having a dynamic viscosity of 134 mPa·s at 23° C., in 198.12 g of decamethylcyclopentasiloxane (B1.1), were initially taken at 50° C. in a 500 ml three-necked flask. 8.96 g (40 mmol) of nonenylsuccinic anhydride IIIa.1 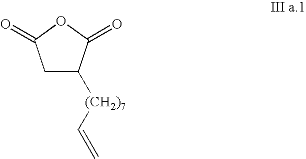
were then added dropwise. The reaction which started took place exothermally, which led to a temperature increase to 66° C. Stirring was then continued for a further 4 hours at 50° C. (conversion according to anhydride titer: 96.7 mol %, determined by titration). Thereafter, 3.48 g (40 mmol) of morpholine were stirred in at 50° C., stirring was continued for a further 15 minutes, and the composition 1 thus obtainable was then cooled to 20-25° C. by external cooling with ice.

Yield: 264.2 g of novel composition 1, 25% by weight of solution of the carboxamide-polysiloxane A1 in B1.1

Dynamic viscosity at 20° C.: 95 mPa·s.

Water content: 0.52% by weight, determined according to DIN 51777.

### EXAMPLE 1.2

90.9 g (23.6 mmol of amino groups) of an amino-containing polysiloxane (amine titer: 0.260 mmol/g, dynamic viscosity: 249 mPa·s at 23° C., on average about 150 silicon atoms per molecule, on average 3 nitrogen atoms in the molecule), comprising randomly distributed structural units IIa.1 (R¹═CH₃, R²═H, Z²═—(CH₂)₃—NH—(CH₂)₂—, IV.1 and V.a.1 (R⁶═CH₃)) in 147.0 g of n-decamethyltetrasiloxane (B1.2) were initially taken at 50° C., 5.05 g (23.6 mmol) of octenylsuccinic anhydride IIIa.2 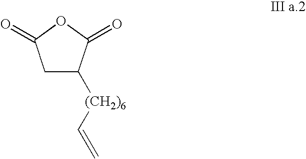
were added dropwise and stirring was carried out for 4 hours at 50° C. (Conversion: 95 mol %, determined by titration.) Thereafter, 2.05 g (23.6 mmol) of morpholine were stirred in at 50° C., stirring was continued for a further 15 minutes and the product was cooled to 20-25° C. by external cooling with ice.

Yield: 245.0 g of composition 2, 40% by weight of solution of the carboxamide-polysiloxane A2 in B1.2.

Dynamic viscosity at 20° C.: 40 mPa·s.

Water content: 0.74% by weight, determined according to DIN 51777.

2. Use of Novel Compositions for Imparting Water Repellency to or Refatting Leather in the Absence of Water

The grain side of a crust leather was sprayed with 10% by weight, based on crust leather, of a novel composition according to example 1.1. Drumming was then effected over a period of one hour in a Dosemat without liquor at 50° C. Thereafter, drying was effected over a period of one hour at 60° C. by hanging out dry, and the performance characteristics were tested after 2 days.

For comparison, a sample of the same crust leather which had not been rendered water repellent or had not been refatted was tested.

TABLE 1
Properties of the leather treated according to the invention and of an
untreated comparative leather sample

| Leather or comparative | According to the | Without imparting water |
|---|---|---|
| leather sample | invention | repellency |
| Formulation used according | 1.1 | — |
| to example | | |
| Bally penetrometer, water | 50 | 5 |
| penetration after [min] | 50 | 5 |
| Static water absorption after | 28 | 129 |
| 6 hours [% by weight] | 31 | 14 |

The water absorption and the water penetration measurements were carried out using a Bally penetrometer. The measurements on the Bally penetrometer were carried out according to 353338, in each case as double determinations. The static water absorption measurement was carried out at 15% compression and stated in % by weight, based on crust leather.

1. A process for the preparation of compositions comprising the following components:
(A) at least one carboxyl-containing polysiloxane which has at least one structural element of the formula Ia, Ib or Ic 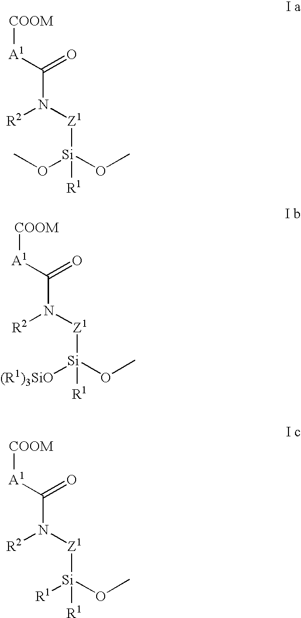
per molecule,
(B1) at least one aprotic substance which is liquid at room temperature or
(B2) at least one organic solvent,
(C) up to 2% by weight, based on the weight of the composition, of water, the variables being defined as follows:
R¹ is hydrogen, hydroxyl, C₁-C₆-alkyl, C₆-C₁₄-aryl or C₁-C₄-alkoxy,
R² is hydrogen or C₁-C₆-alkyl,
Z¹ is C₂-C₂₅-alkylene, C₃-C₁₀-cycloalkylene, C₆-C₁₄-arylene, —[(CH₂)ₙ—NR²—(CH₂)ₘ]ₚ, 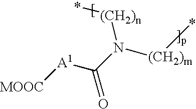
n and m are integers which are identical or different and are from 1 to 10,
p is an integer from 1 to 5,
A¹ is C₂-C₂₀-alkylene, unsubstituted or substituted by R³ and/or R⁴, —CH═CR³—, —CR⁴═CR³—, 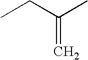
R³ and R⁴ are identical or different and are selected from hydrogen, C₁-C₂₀-alkyl, C₂-C₂₀-alkenyl, C₆-C₁₄-aryl and C₁-C₄-alkoxy;
it being possible for R³ and R⁴ to be linked to one another with formation of a mono- or bicyclic system,
M are identical or different and are selected from hydrogen, alkali metal and ammonium, which may be substituted or cyclic,
wherein at least one amino-containing polysiloxane which has at least one structural element of the formula IIa, IIb or IIc 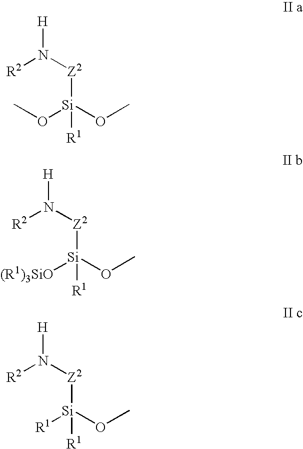
per molecule is reacted, in the presence or absence of component (B1),
with at least one dicarboxylic anhydride of the formula IIIa or at least one dicarboxylic acid derivative of the formula IIIb 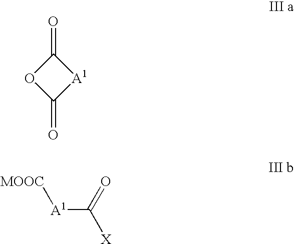
X being a leaving group and
Z² being C₂-C₂₅-alkylene, C₃-C₁₀-cycloalkylene, C₆-C₁₄-arylene or —[(CH₂)ₙ—N R²—(CH₂)ₘ]ₚ,
and then, if required, component (B1) or (B2) is added.

2. A process as claimed in claim 1, wherein the carboxyl-containing polysiloxane (A) is a polysiloxane which has structural elements of the formulae IV and optionally Va and Vb

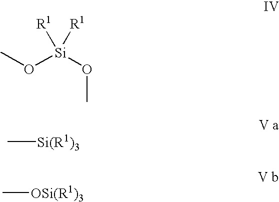

3. A process as claimed in claim 1, wherein carboxyl groups of the structural elements of the formula Ia to Ic are partially or quantitatively neutralized with amine.

4. A process as claimed in claim 1, wherein component (B1) is an ester of a C₁-C₁₀-carboxylic acid or a linear, branched or cyclic carboxyl-free polysiloxane.

5. A process as claimed in claim 1, wherein component (B1) is a cyclic carboxyl-free polysiloxane.

6. A composition obtainable by a process as claimed in claim 1.

7. A composition as claimed in claim 6, which contains, as a further component (D), at least one substance which is solid at room temperature.

8. A composition as claimed in claim 6, which contains, as a further component (E), at least one emulsifier.

9. A composition as claimed in claim 6, wherein at least one carboxyl-containing polysiloxane (A) has a carboxyl content of from 0.02 to 1.0 meq/g.

10. A composition as claimed in claim 6, wherein at least one carboxyl-containing polysiloxane (A) has an average molar mass Mₙ of from 2 000 to 60 000 g/mol.

11. A composition as claimed in claim 6 for imparting water repellency to or refatting materials having a fibrous structure.

12. A process for imparting water repellency to or refatting materials having a fibrous structure, comprising the following steps:
a) applying a composition as claimed in claim 6 to material having a fibrous structure,
b) allowing to act with or without simultaneously carrying out mechanical treatment steps and
c) optionally washing and drying.

13. A process for imparting water repellency to or refatting materials having a fibrous structure as claimed in claim 12, wherein, in step (a), a the composition is applied to material having a fibrous structure by spraying on.
